(19) United States
(12) Patent Application Publication
(10) Pub. No.: US 2002/0099742 A1
(43) Pub. Date: Jul. 25, 2002

(54) System and method for document preparation

(75) Inventors: Robert Basil Antley, Greer, SC (US); Michael Anthony Cocca, Atlanta, GA (US); Richard Jonh Keck, Simpsonville, SC (US); James Quentin Powers, Simpsonville, SC (US); John Thomas, Fultonville, NY (US)

Correspondence Address: BANNER & WITCOFF LTD, GENERAL ELECTRICCOMPANY, 1 RIVER ROAD, SCHENECTADY, NY, 12345, US

(73) Assignee: General Electric Company, Schenectady, NY

(21) Appl. No.: 09/765,982

(22) Filed: Jan. 19, 2001

(51) Int. Cl. G06F 17/21

(52) U.S. Cl. 707/530; 707/3

(57) ABSTRACT

A system and method for document preparation includes a workstation, a web browser, databases, and an application server with a relational database and word processing software, the application server disposed between the web browser and the databases. A document is prepared by retrieving one or more data items from the databases in response to user action and emplacing the retrieved data items into a word processing template retrieved from the application server. A relational database in the application server correlates user action to certain data items in the databases and to a certain template in the application server.

### COPYRIGHT NOTIFICATION

The present Patent Specification and Figures contain materials that are subject to copyright protection. The copyright owner does not have an objection to the facsimile reproduction of the patent document as it appears in the files of the U.S. Patent and Trademark Office, but otherwise reserves all other copyright rights whatsoever.

### FIELD OF THE INVENTION

This invention relates to document preparation and, in particular, to a system and method for automatically preparing documents using data items retrieved from databases.

### BACKGROUND OF THE INVENTION

Document preparation has been greatly facilitated with the availability of personal computers and word processing software. When documentation is produced and edited in electronic form, the need for repetitively entering the same data or text is largely eliminated. Instead, the user can copy existing data or text, and insert the same into a new location, a process often referred to as ‘cut-and-paste.’ As useful as this process has been, certain limitations have become apparent. In particular, there is the problem of retrieving information from older database configurations, commonly referred to as ‘legacy databases.’ When a particular legacy database has been in existence for many years, it will most likely contain a great deal of data which is still useful. However, accessing the data from multiple legacy databases is problematic. Typically, when a user requires data from more than one legacy database, such as in the process of assembling a report or similar types of documentation, he is required to move from one screen to another to access the information. That is, a different, dedicated database access screen must be called up in turn to retrieve data from the particular database accessed. This requirement makes it impractical to access multiple legacy databases while working in a word processing application, and adds greatly to the time required for the preparation of documents.

Thus, there is a particular need for a system and method for more efficiently assembling reports and documentation which include information retrieved from multiple databases, including legacy databases.

### BRIEF SUMMARY OF THE INVENTION

A system for preparing documents includes a workstation, a web browser, databases, and an application server with a relational database and word processing software, the application server disposed between the web browser and the databases. The relational database links certain identifier terms to one or more data items in the databases and to a word processing template. A document is prepared by inputting an identifier term into the system, which system emplaces data items related to the inputted identifier term into a word processing template related to the inputted identifier term.

### BRIEF DESCRIPTION OF THE DRAWINGS

FIG. 1 is a basic block diagram of a conventional document preparation system;

FIG. 2 is a basic block diagram of a document preparation system including a workstation, a web server, an application server, and a plurality of databases;

FIG. 3 is a flow diagram illustrating operation of the documentation preparation system of FIG. 2;

FIG. 4 is a preferred embodiment of a document preparation screen accessed via the method described in the flow diagram of FIG. 3;

FIG. 5 is a first home page which can be accessed from the document preparation screen of FIG. 4;

FIG. 6 is a second home page which can be accessed from the document preparation screen of FIG. 4;

FIG. 7 is a third home page which can be accessed from the document preparation screen of FIG. 4;

FIG. 8 is a fourth home page which can be accessed from the document preparation screen of FIG. 4; and

FIG. 9 is a fifth home page which can be accessed from the document preparation screen of FIG. 4.

### DETAILED DESCRIPTION OF THE INVENTION

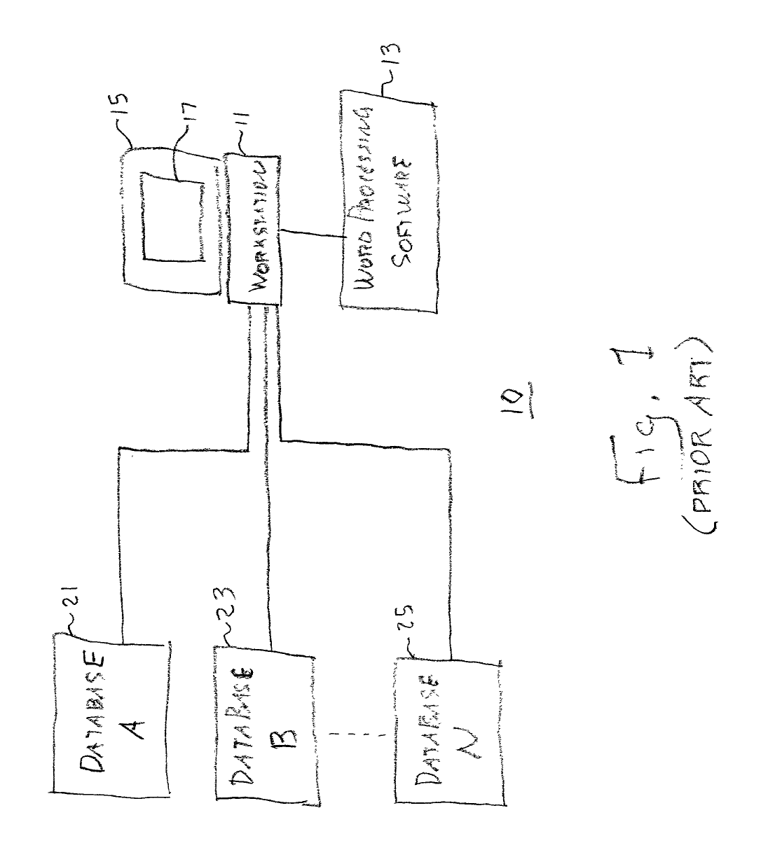

There is shown in FIG. 1 a diagrammatical representation of a conventional document preparation system 10. The documentation preparation system 10 includes a workstation 11 from which a user may access word processing software 13. The word processing software 13 allows the user to create and edit a document appearing in the word processing screen 17 of a display device 15. The document being edited by the user at the workstation 11 may include informational data retrieved from any of a plurality of databases, represented in the diagram by a first database 21 (Database A), a second database 23 (Database B), through an nth database 25 (Database N). One or more of the databases 21-25 may be a legacy database, where each legacy database is accessed via a unique, associated search screen. Typically, one legacy database cannot be accessed via the search screen of another legacy database.

Accordingly, to access data from the first database 21, for example, it may be required for the user to switch from the word processing screen 17 to a first database search screen (not shown). From the first database search screen, the user searches for and retrieves a particular data item he wishes to add to the document, typically using a cut-and-paste operation. When the desired information has been found and copied, the user switches from the first database search screen to the word processing screen 17 and completes the cut-and-paste operation.

When the user next requires a data item from the second database 23, he switches from the word processing screen 17 to a second database search screen (not shown) and proceeds with a search and retrieval in the second database 23. The data item of interest is copied from the second database 23 and ‘pasted’ into the document by switching back to the word processing screen 17. This process of switching among word processing and database search screens results in a great deal of additional time spent in preparing the document, especially when it is necessary for the user to use a different search screen for each database to be accessed in the document preparation system 10.

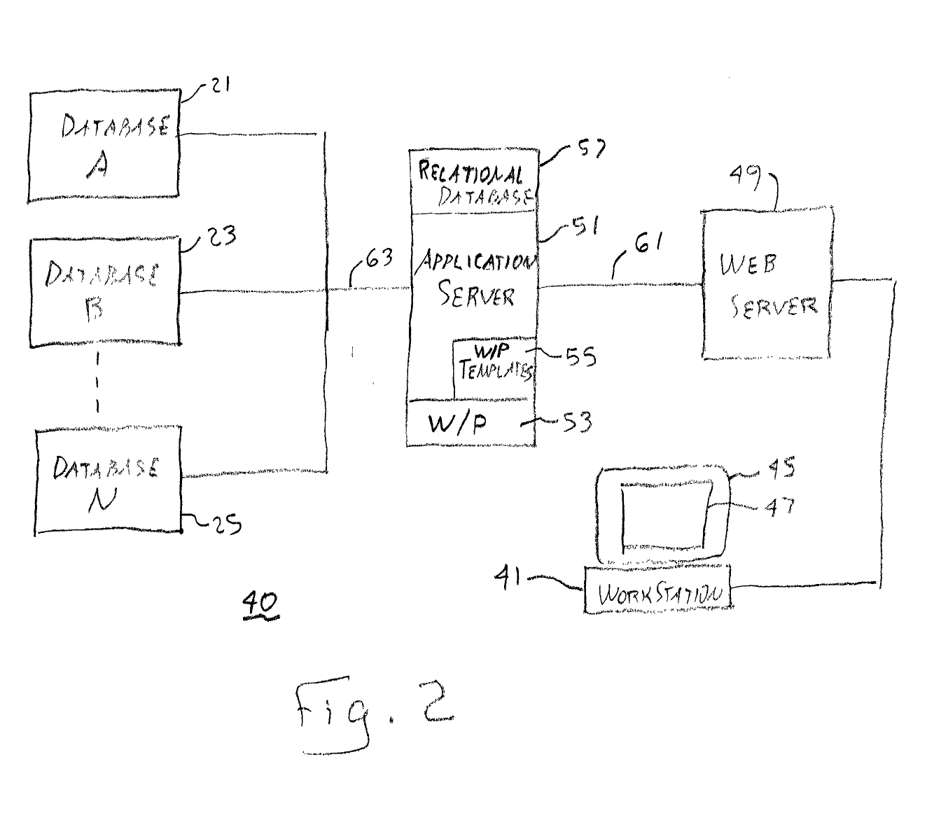

FIG. 2 is a diagrammatical representation of a documentation preparation system 40 in accordance with the present invention. The documentation preparation system 40 includes a workstation 41 connected to a web server 49. The web server 49 provides the user access to an application server 51 via a first communication network 61. The application server has access to the databases 21-25 via a second communication network 63. The application server 51 includes word processing software 53, word processing templates 55, and a relational database 57, such as an Oracle® database which can be accessed using SQL. A user at the workstation 41 prepares a document by means of a document preparation access screen 47 appearing on a display device 45, such as a monitor. In the document preparation system 40 of the present invention, the user is able to initiate an automatic process of cut-and-pasting information from the databases 21-25 without being required to move among a word processing screen, for example, and one or more database screens, as described in greater detail below.

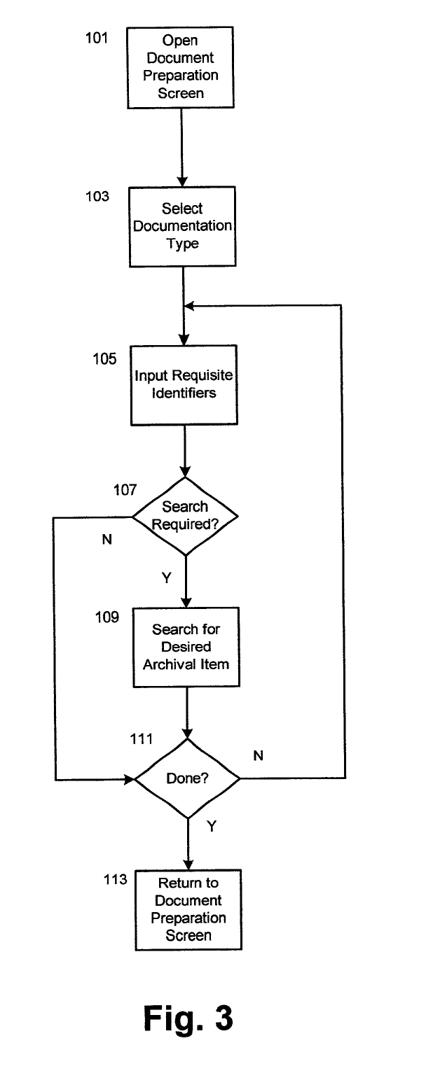

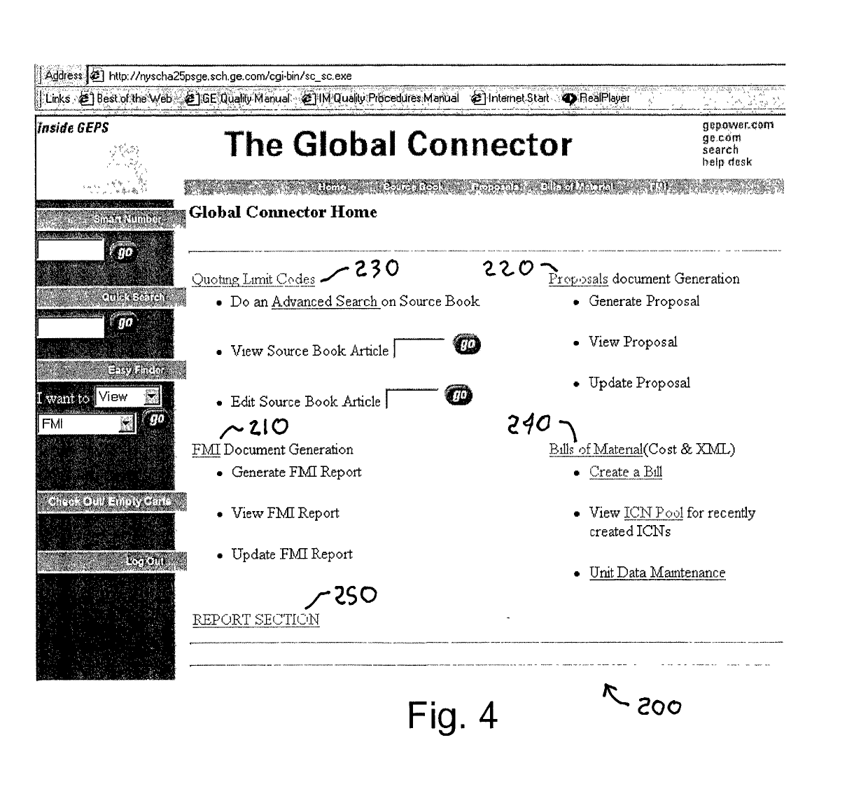

Operation of the invention can be explained with reference to FIGS. 3-9. In a preferred embodiment, the user initiates operation by accessing a document preparation access screen 200 via a web browser, such as Netscape® or Explorer®, at step 101 in FIG. 3. The document preparation access screen 200, as best seen in FIG. 4, allows for selecting one of five documentation types, here denoted as a Field Modification Instruction (FMI) document selection 210, a Proposal selection 220, a Quoting Limit Codes (QLC) selection 230, a Bills of Material (BOM) selection 240, and a Report selection 250. It should be understood that the present invention is not limited to five documentation types as shown, and that more or fewer may be provided on the document preparation access screen 200 in accordance with user needs. Clicking on any of these selections will bring up a document-type selection home page, at step 103.

In the preferred embodiment, the documentation preparation system 40 includes the following legacy databases: a Communication Oriented Production Information and Control System (COPICS) database used for the manufacturing shop floor, a Customer Order Service Data and Order Management (COSDOM) database, a CONFIG database, a PEGASUS database which includes customer order information, a DOCSTATS database, a TIM database, and a TIMES database. As discussed above, these legacy systems require individual user/system interfaces and are not transactive from one user system to another. When incorporated into the document preparation system 40 in accordance with the present invention, the need for the user to interact with multiple legacy interfaces is eliminated.

The document preparation system 40 provides a machine-independent transactive link that allows inquiry and update capability in the respective legacy systems through web-based, single-user interfaces. The user acquires the capability to search more than one legacy system simultaneously, in effect transcending the various legacy database boundaries.

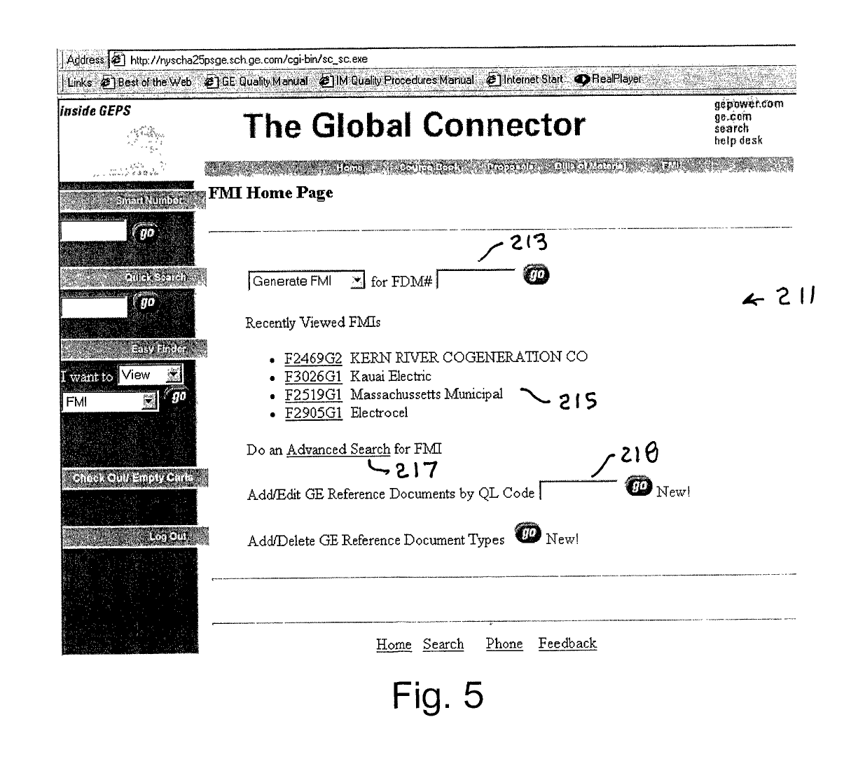

Clicking on the FMI document selection 210, for example, will bring up an FMI home page 211, shown in FIG. 5. The FMI home page 211 provides resources to automatically create FMIs through the process of search and retrieval of data items contained in the databases 21-25. There is provided the functionality of generating an FMI at an entry point 213, and a provision for retrieval of FMI documents previously created by the user at a document list 215, here shown as a list of four documents.

When an existing Field Design Memo (FDM) number is entered into the entry point 213, at step 105, the application server 51 responds by retrieving the corresponding data item, which then can be further edited by the user. If a new FDM number is entered, the application server responds by accessing the data item related to the new FDM number, and generates essentially the entire FMI document required by the user, in a word processing format. From the FMI home page 211, data items related to the new FDM number are retrieved from COPICS, COSDOM, PEGASUS, and CONFIG for incorporation into the new FMI document. The automatic process by which the new FMI document is prepared follows the search, cut, and paste steps the user would have otherwise performed manually.

At this stage, the user has an essentially completed FMI document which he may edit, if desired, using the word processing application. If all relevant data items have been included in the new FMI document, no further searching is required, at decision block 107, the document preparation is completed, at decision block 111, and the user may return to the document preparation access screen 200, at step 113.

If the user wishes to access documents created by other users, he may perform a document search via an search access point 217. There is also provided an entry point 218 for adding one or more reference documents to the FMI document. By entering a Quoting Limits (QL) code, the respective document is added to the table of contents of the current FMI document being prepared. The reference document added to the FMI document may comprise reference text and illustrations for assisting service personnel, for example.

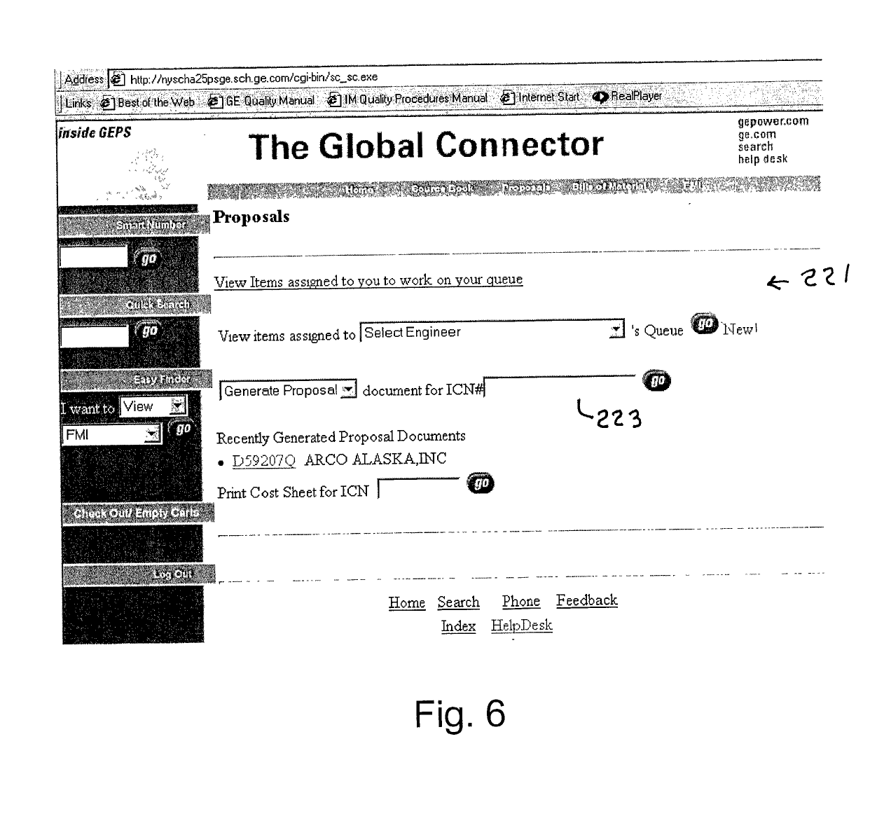

Clicking on the Proposals selection 220, for example, will bring up a Proposals home page 221, shown in FIG. 6. The Proposals home page 221 enables the user to automatically create customer proposals by inputting an Internal Control Number (ICN) to the entry point 223. Assignment of an ICN number provides permission to proceed with the preparation of a proposal. In response to the entry of the ICN number, the application server 51 brings up a proposal template and retrieves relevant data items from the COSDOM database. The Proposal home page 221 also provides the functionality of writing and storing proposals for future inquiry. When a particular proposal has been approved by an authorized administrator, the approved proposal is entered into a corresponding database.

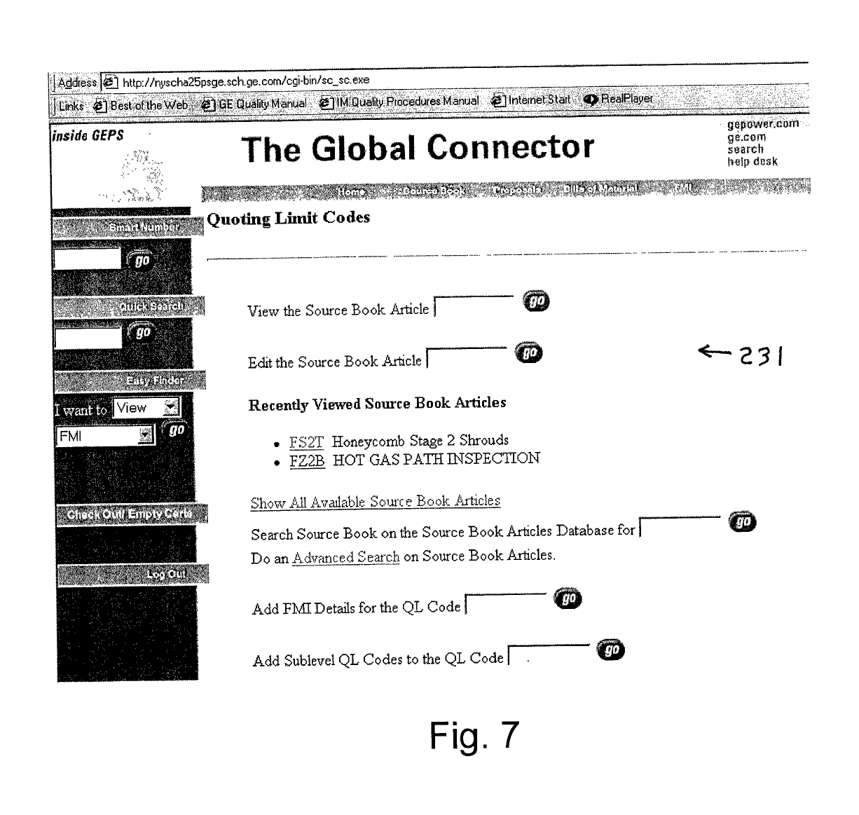

By clicking on the Quoting Limits Codes selection 230, the user brings up a QLC home page 231, shown in FIG. 7. The QLC home page 231 is a single repository of technical Source Book articles resident in the relational database 57. In a preferred embodiment, a Source Book may contain descriptions of gas turbine products. The Source Book articles have been converted from documents in word processing format, such as Word® documents, to database fields, so as to enable searching by the relational database 57. The conversion of the documents to database fields also allows the documentation preparation system 40 to utilize sections of the Source Book articles while other documents are being prepared by other users.

When in the QLC home page, the user can perform searches of the Source Book articles after the initial QLC document has been prepared. This corresponds to a response of ‘Yes’ at the decision block 107 and enables the user to conduct his search for a desired archival item, at step 109. When the desired archival item has been retrieved, the user proceeds to enter another identifier term, at step 105 if the response to the decision block 111 is ‘No,’ and returns to the document preparation screen 200 if the response to the decision block 111 is ‘Yes.’

The QL codes have a full description of modifications that can be performed on a customer's equipment. The application server can initiate a search to determine which QL codes are cross-referenced to another document, such as an engineering drawing. These data items are obtained from the relational database 57 and from the legacy databases, including TIMES and PEGASUS.

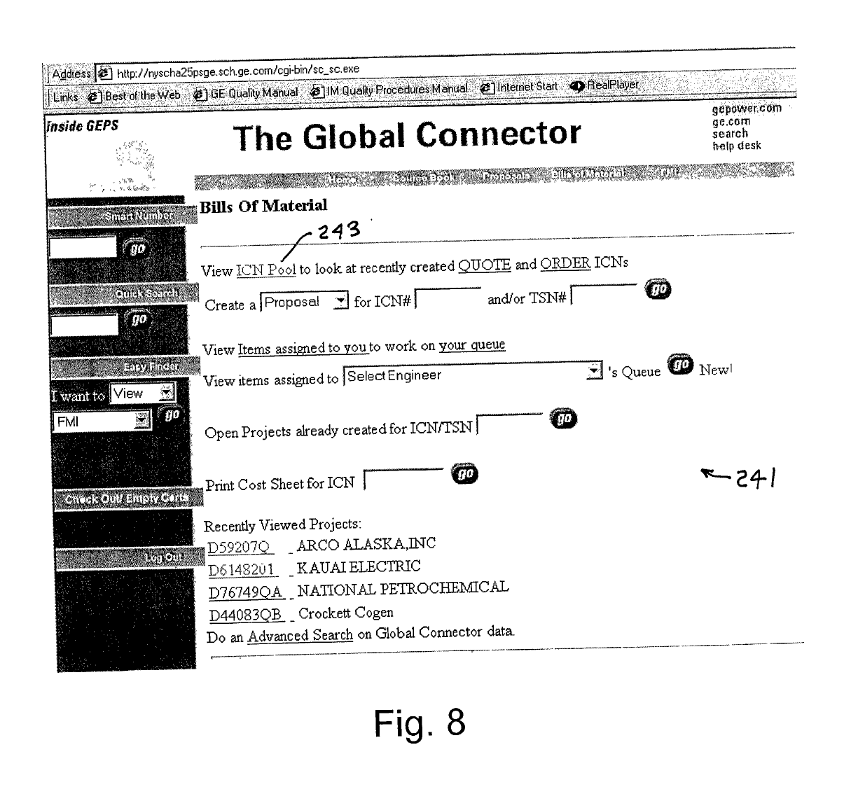

By clicking on the Bills of Material selection 240, the user brings up a BOM home page 241, shown in FIG. 8. The BOM home page 241 distinguishes between a QUOTE ICN and an ORDER ICN. The QUOTE ICN is assigned to a user for the purpose of producing a Cost BOM. The QUOTE ICN can be subsequently converted into an ORDER ICN. The cost BOM link provides for development of the Cost BOM for customer proposal using multiple data sources. The cost BOM link also provides the functionality of search and retrieval, and functions to add user inputs to the Cost BOM.

The ORDER ICN is written into the various databases and is used to produce an exception model list BOM. The exception model list BOM link provides the ability to search the databases through a real-time interface. The user is further provided the means to select the data items retrieved, and to write back the data items to the databases 21-25. The application server 51 functions to determine the correct BOM items to include in the document. In addition, the application server 51 provides a list of BOM items for selection by the user.

Viewing an ICN Pool 243 results in a real-time data retrieval of ICNs from the COSDOM database. The administrator for an application engineering group can then transactively assign the QUOTE ICN to a user by writing the user's name to the COSDOM database. The user can then generate Cost BOMs by using either legacy data items or new data. Similarly, the administrator for a requisition engineering group can transactively assign the ORDER ICN to a user by writing the user's name to COSDOM and PEGASUS.

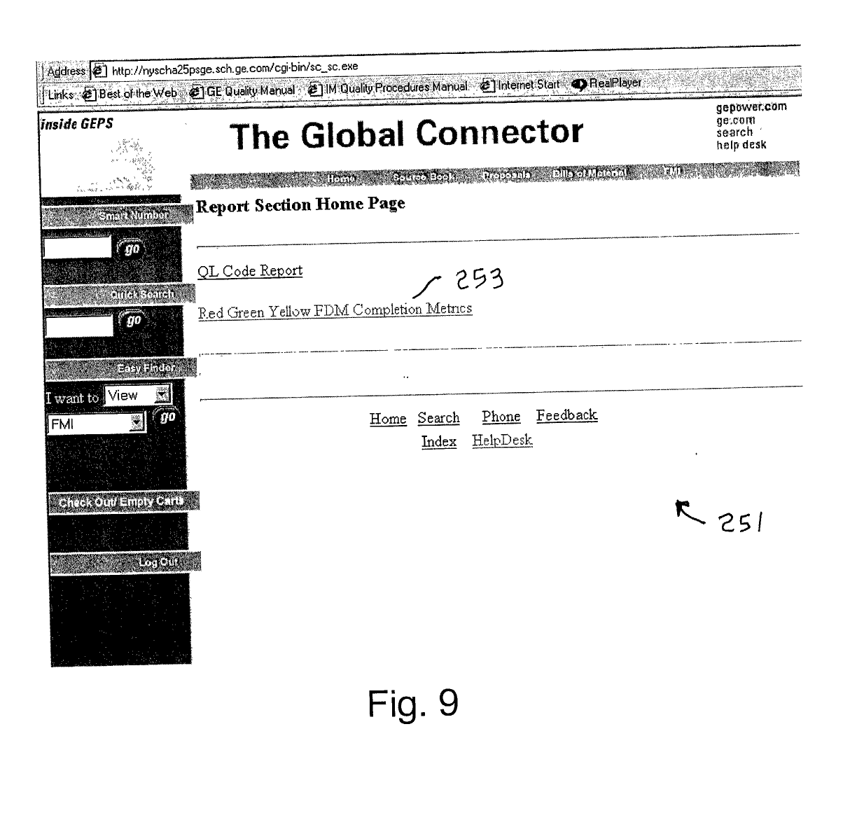

By clicking on the Report selection 250, the user brings up a Report home page 241, shown in FIG. 9. The Report home page 241 provides the user the capability to generate reports from data items contained in the TIMES and PEGASUS databases. A typical report will provide the status of an Order to Remittance (OTR) process related to a customer's requirements. Clicking on the Red Green Yellow FDM Completion Metric link 243 brings up a spreadsheet having various individual entries color-coded for a quick visual status indication. For example, the spreadsheet may contain project criteria, cross-referenced to a respective project engineer, and color coded red, green, or yellow depending upon the status of the customer shipping date.

The Report generated via the Report home page 241 provides a method of viewing the work load of employees in a format particularly suitable for a manager. The data items in the Report are obtained from the TIMES and PEGASUS legacy databases, and from the relational database 57.

Clicking on the Proposals selection 220, for example, will bring up a Proposals home page 221, shown in FIG. 6. The Proposals home page 221 enables the user to automatically create customer proposals by inputting an Internal Control Number (ICN) to the entry point 223.

While the invention has been described with reference to a preferred embodiment, it will be understood by those skilled in the relevant art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system for automatically preparing a document in response to action by a user, said system comprising:
a plurality of databases, each said database including a plurality of data items;
a web server providing access to a first communications network;
a workstation enabling the user to access said first communications network via said web server;
an application server linked to said first communications network so as to provide a connection with said web server when requested by the user, said application server further linked to a second communications network so as to provide a connection with said plurality of databases, said application server including;
a relational database, said relational database relating data items in the databases to a plurality of identifier terms;
a word processing application;
a plurality of word processing templates, said relational database further relating said plurality of word processing templates to said plurality of identifier terms;
said application server further including
means for retrieving a first set of data items related to a first said identifier term in response to the receipt by said application server of said first identifier term;
means for retrieving at least a first said template related to said first said identifier term in response to the receipt by said application server of said first identifier term; and
means for emplacing said first set of retrieved data items into said first template to produce a first document formatted in accordance with said word processing application;
such that said application server provides said first document to the user in response to the action by the user of inputting said first identifier term into said workstation.

2. The system of claim 1 wherein said plurality of databases comprises at least one legacy database.

3. The system of claim 1 wherein said identifier term comprises an alphanumeric term.

4. A method for preparing a document by using a workstation, said method comprising the steps of,
opening a document preparation screen at the workstation, said document preparation screen displaying a plurality of documentation types;
selecting a documentation type from said document preparation screen;
inputting an identifier term to an application server via the workstation;
relating said identifier term to a word processing template resident in said application server;
relating said identifier term to at least one data item resident in at least one database;
retrieving said word processing template;
retrieving said at least one data item;
emplacing said at least one data item into said word processing template so as to produce a document; and
returning said produced document to the workstation.
